(19) United States
(12) Patent Application Publication
(10) Pub. No.: US 2024/0203639 A1
(43) Pub. Date: Jun. 20, 2024

(54) COIL COMPONENT AND MANUFACTURING METHOD THEREFOR

(71) Applicant: TDK Corporation, Tolyo (JP)

(72) Inventors: Yuuichi KAWAGUCHI, Tokyo (JP); Hironori SATO, Tokyo (JP); Azuma SATOH, Akita (JP); Liyi CHEN, Tokyo (JP)

(21) Appl. No.: 18/537,468

(22) Filed: Dec. 12, 2023

(30) Foreign Application Priority Data
Dec. 14, 2022 (JP) 2022-199454

(51) Int. Cl. H01F 27/32; H01F 27/29; H01F 41/12

(52) U.S. Cl. CPC H01F 27/324; H01F 27/29; H01F 41/12

(57) ABSTRACT

Disclosed herein is a coil component that includes a magnetic element body having a mounting surface, a coil pattern embedded in the magnetic element body, a conductor post embedded in the magnetic element body, the conductor post having a first end connected to the coil pattern and a second end, and a terminal electrode connected to the second end of the conductor post through an opening formed in the cover insulating film. The second end of the conductor post is flush with a surface of the cover insulating film.

### CROSS-REFERENCE TO RELATED APPLICATION

This application claims the benefit of Japanese Patent Application No. 2022-199454, filed on Dec. 14, 2022, the entire disclosure of which is incorporated by reference herein.

### BACKGROUND OF THE ART

### Field of the Art

The present disclosure relates to a coil component and a manufacturing method therefor and, more particularly, to a coil component having a structure in which a coil pattern and a conductor post connected thereto are embedded in a magnetic element body and a manufacturing method for such a coil component.

### Description of Related Art

JP 2017-199798A discloses a coil component having a structure in which a coil pattern and a conductor post connected thereto are embedded in a magnetic element body. In the invention disclosed in JP 2017-199798A, a mounting surface of the magnetic element body is covered with an insulating film, and a terminal electrode is provided on the insulating film.

In the coil component described in JP 2017-199798A, the insulating film covering the mounting surface of the magnetic element body has an opening, through which the terminal electrode and a conductor post are connected to each other.

### SUMMARY

The present disclosure describes a technology for achieving, in a coil component having a structure in which a coil pattern and a conductor post connected thereto are embedded in a magnetic element body and a manufacturing method therefor, a high-reliability component without requiring high positional accuracy of the opening formed in the insulating film.

A coil component according to one aspect of the present disclosure includes a magnetic element body having a mounting surface, a coil pattern embedded in the magnetic element body, a conductor post embedded in the magnetic element body, the conductor post having a first end connected to the coil pattern and a second end, and a terminal electrode connected to the second end of the conductor post through an opening formed in the cover insulating film. The second end of the conductor post is flush with a surface of the cover insulating film.

A coil component manufacturing method according to one aspect of the present disclosure includes: embedding, in a magnetic element body, a coil pattern and a conductor post having a first end connected to the coil pattern and a second end exposed from a mounting surface of the magnetic element body; forming a cover insulating film on the second end of the conductor post and the mounting surface of the magnetic element body and making the second end of the conductor post protrude from the mounting surface of the magnetic element body; polishing a surface of the cover insulating film to such a degree that the second end of the conductor post is exposed and that the cover insulating film covering the mounting surface is left; and forming a terminal electrode on the second end of the conductor post.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view for explaining the outer appearance of a coil component 1 according to an embodiment of the present disclosure;

FIG. 2 is a schematic cross-sectional view of the coil component 1;

FIG. 3 is a schematic plan view for explaining the pattern shape of the conductor layer C0;

FIG. 4 is a schematic plan view for explaining the pattern shape of the conductor layer C1;

FIG. 5 is a schematic plan view for explaining the pattern shape of the conductor layer C2;

FIG. 6 is a schematic plan view for explaining the pattern shape of the conductor layer C3;

FIGS. 7 to 16 are process views for explaining the manufacturing method for the coil component 1; and

FIG. 17 is a schematic cross-sectional view for explaining the surface state of the cover insulating film 21.

### DETAILED DESCRIPTION OF THE EMBODIMENTS

Preferred embodiments of the present disclosure will be explained below in detail with reference to the accompanying drawings.

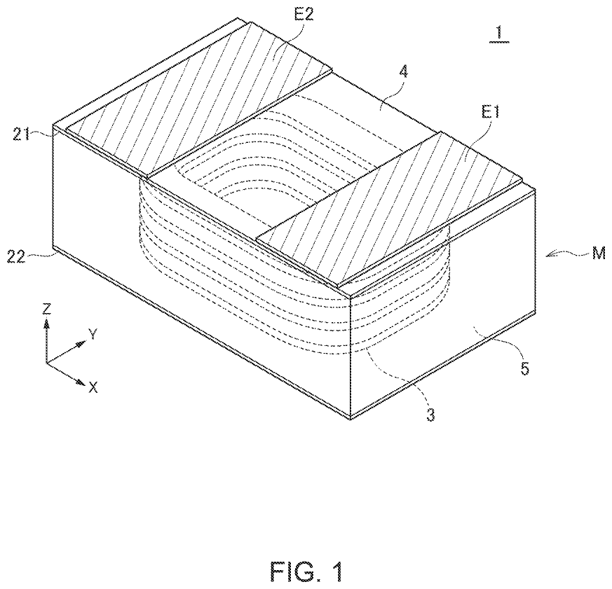

FIG. 1 is a schematic perspective view for explaining the outer appearance of a coil component 1 according to an embodiment of the present disclosure.

As illustrated in FIG. 1, the coil component 1 according to the present embodiment is a chip type coil component having a structure in which a coil part 3 having a coil axis extending in the Z-direction is embedded in a magnetic element body M. The magnetic element body M has a mounting surface 4 and an upper surface 5 which are orthogonal to the coil axis and constitute the XY plane. The mounting surface 4 and upper surface 5 are positioned on the opposite sides to each other. The mounting surface 4 is provided with terminal electrodes E1 and E2. At the time of mounting, the terminal electrodes E1 and E2 are soldered onto a circuit board with the mounting surface 4 facing the circuit board. That is, the vertical direction of the coil component 1 illustrated in FIG. 1 differs by 180° from that at the time of mounting.

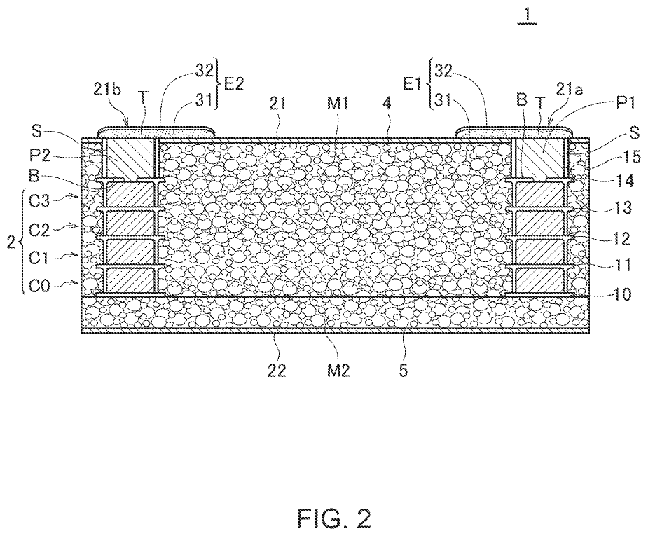

FIG. 2 is a schematic cross-sectional view of the coil component 1 according to the present embodiment.

As illustrated in FIG. 2, the coil component 1 according to the present embodiment has interlayer insulating films 10 to 14 and conductor layers C0 to C3 which are alternately stacked in the coil axial direction (Z-direction). The conductor layers C0 to C3 are made of Cu or the like and constitute a coil part 3. The magnetic element body M includes magnetic resin layers M1 and M2. The magnetic resin layer M1 is positioned in the inner diameter area and radially outside area of the coil part 3 and on one side in the coil axis direction of the coil part 3. The magnetic resin layer M2 is provided on the other side in the coil axial direction of the coil part 3. The magnetic resin layers M1 and M2 are made of a composite magnetic material containing a magnetic filler and binder resin. The composite magnetic material constituting the magnetic resin layer M1 and composite magnetic material constituting the magnetic resin layer M2 may be the same or different. The magnetic filler may be a metal magnetic material such as iron (Fe) or a permalloy-base material. The binder resin may be epoxy resin.

Conductor posts P1 and P2 are embedded in the magnetic resin layer M1. The conductor posts P1 and P2 are made of Cu or the like and are pillar-shaped conductors extending in the Z-direction. A lower surface B at one end of the conductor post P1 is connected to one end of a coil constituted by the conductor layers C0 to C3, and a lower surface B at one end of the conductor post P2 is connected to the other end of the coil constituted by the conductor layers C0 to C3. On the other hand, upper surfaces T at the other ends of the respective conductor posts P1 and P2 are exposed from the mounting surface 4 are connected respectively to the terminal electrodes E1 and E2. Side surfaces S (surfaces along the Z-direction) of the conductor posts P1 and P2 are covered with a post protective film 15. Thus, the post protective film 15 is interposed between the magnetic element body M and the conductor posts P1 and P2, so that contact between the magnetic element body M and the conductor posts P1 and P2 is prevented to insulate them from each other. Further, when the coil component 1 according to the present embodiment having the thus configured conductor posts P1 and P2 is mounted on a circuit board or the like, stress is relaxed by the conductor posts P1 and P2 to reduce damage to the coil part 3. This increases mounting reliability of the coil component 1.

The mounting surface 4 and upper surface 5 of the magnetic element body M are covered respectively with cover insulating films 21 and 22. The cover insulating film 22 covers substantially the entire upper surface 5, while the cover insulating film 21 has openings 21a and 21b exposing respectively therethrough the conductor posts P1 and P2. As a result, the upper surfaces T (XY plane) of the respective conductor posts P1 and P2 are exposed through the respective openings 21a and 21b of the cover insulating film 21. On the upper surfaces T of the respective conductor posts P1 and P2 exposed respectively through the openings 21a and 21b, the terminal electrodes E1 and E2 are provided. The terminal electrodes E1 and E2 may each partly be positioned on the surface of the cover insulating film 21. The terminal electrodes E1 and E2 are each constituted by a conductor layer 31 which is made of a conductive resin material containing metal powder of Ag and binder resin and a conductor layer 32 which is made of metal and formed on the surface of the conductor layer 31. Therefore, a conductive material constituting the conductor layer 32 has a resistance value lower than that of a conductive material constituting the conductor layer 31.

The conductor layer 32 may be a laminated film of a plurality of metals such as Ni and Sn. The laminated film of Ni and Sn has a sufficiently lower resistance than a conductive resin material such as a silver paste and has high solder heat resistance and high solder wettability. On the other hand, as compared with the conductor layer 32 positioned in the upper layer, the conductor layer 31 positioned in the lower layer can provide high adhesion to the cover insulating film 21 and relax thermal shock and external stress thanks to high flexibility of conductive resin, thus increasing reliability.

Since the mounting surface 4 of the magnetic element body M is thus covered with the cover insulating film 21, contact between the magnetic element body M and the terminal electrodes E1 and E2 is prevented, thereby increasing product reliability. The upper surfaces T of the respective conductor posts P1 and P2 are not covered with the cover insulating film 21 but entirely covered respectively with the terminal electrodes E1 and E2. The upper surfaces T of the respective conductor posts P1 and P2 are flush or substantially flush with the surface of the cover insulating film 21. This increases the contact area between the conductor post P1 and the terminal electrode E1 and the contact area between the conductor post P2 and the terminal electrode E2, thus allowing reduction in contact resistance therebetween. In addition, since the upper surfaces T of the respective conductor posts P1 and P2 are not covered with the cover insulating film 21, the height of the entire coil component 1 can be reduced. Further, the end surface of the post protective film 15 is also exposed from the mounting surface 4. The post protective film 15 contacts the cover insulating film 21, and the upper end surface thereof is flush or substantially flush with the upper surface T of each of the conductor posts P1 and P2 and the surface of the cover insulating film 21. Thus, the side surface S of each of the conductor posts P1 and P2 is reliably protected by the post protective film 15. Furthermore, the upper surface 5 of the magnetic element body M is covered with the cover insulating film 22, thus increasing product reliability and allowing a direction mark or the like to be provided on the upper surface 5.

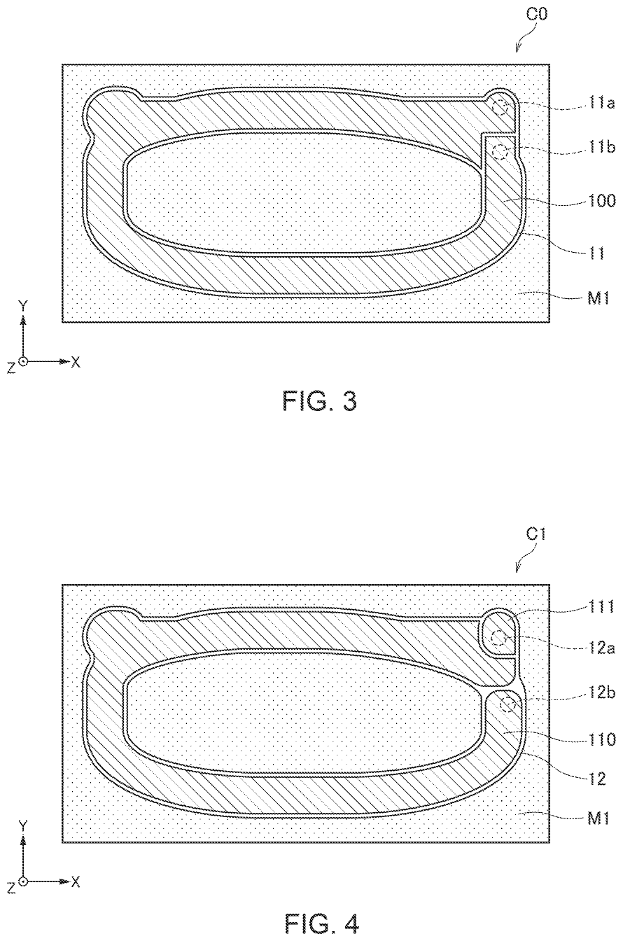

FIGS. 3 to 6 are schematic plan views for explaining the pattern shapes of the conductor layers C0 to C3.

As illustrated in FIG. 3, the conductor layer C0 is provided with a coil pattern 100. The coil pattern 100 is a pattern wound in about one turn, and both ends thereof are connected to the conductor layer C1 through vias 11a and 11b.

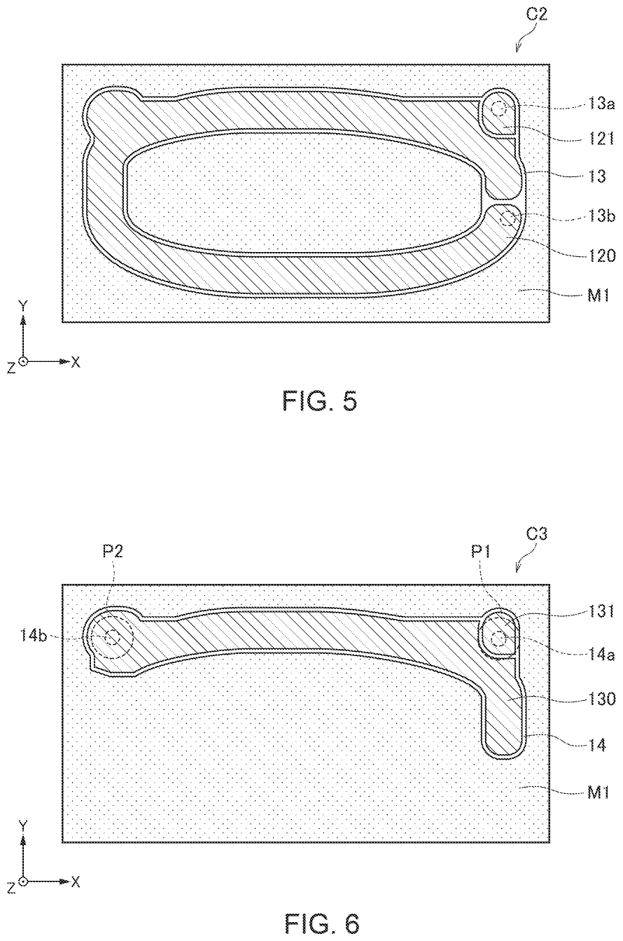

As illustrated in FIG. 4, the conductor layer C1 is provided with a coil pattern 110 and a connection pattern 111. The coil pattern 110 is a pattern wound in about one turn. One end of the coil pattern 110 is connected to the other end of the coil pattern 100 in the conductor layer C0 through the via 11b formed in the interlayer insulating film 11, and the other end thereof is connected to the conductor layer C2 through a via 12b formed in the interlayer insulating film 12. The connection pattern 111 is provided at a position overlapping the one end of the coil pattern 100 in the conductor layer C0. The connection pattern 111 is connected to the one end of the coil pattern 100 in the conductor layer C0 through a via 11a formed in the interlayer insulating film 11 and to the conductor layer C2 through a via 12a formed in the interlayer insulating film 12.

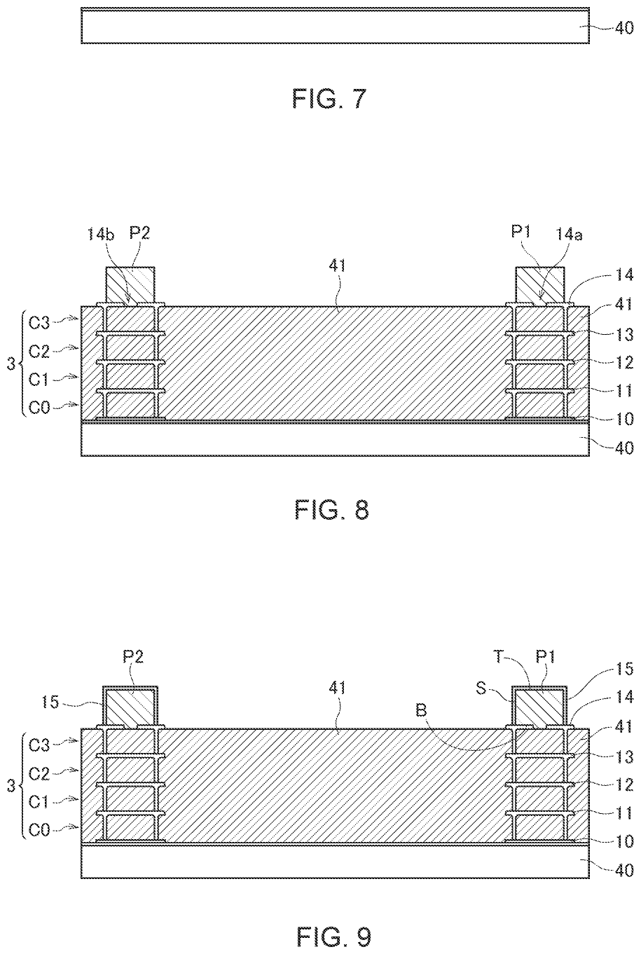

As illustrated in FIG. 5, the conductor layer C2 is provided with a coil pattern 120 and a connection pattern 121. The coil pattern 120 is a pattern wound in about one turn. One end of the coil pattern 120 is connected to the other end of the coil pattern 110 in the conductor layer C1 through the via 12b formed in the interlayer insulating film 12, and the other end thereof is connected to the conductor layer C3 through a via 13b formed in the interlayer insulating film 13. The connection pattern 121 is provided at a position overlapping the connection pattern 111 provided in the conductor layer C1. The connection pattern 121 is connected to the connection pattern 111 in the conductor layer C1 through the via 12a formed in the interlayer insulating film 12 and to the conductor layer C3 through a via 13a formed in the interlayer insulating film 13.

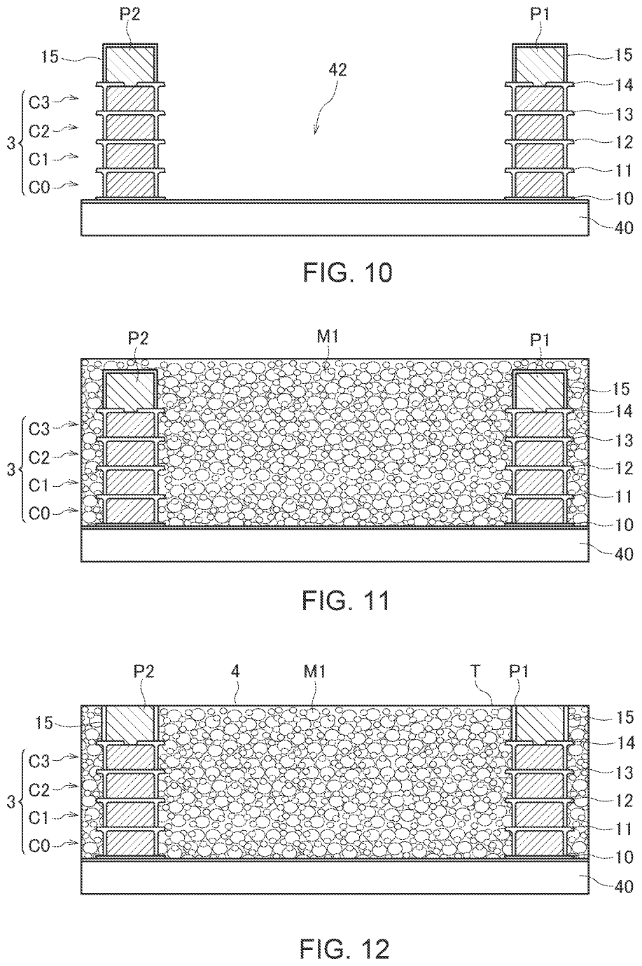

As illustrated in FIG. 6, the conductor layer C3 is provided with a coil pattern 130 and a connection pattern 131. The coil pattern 130 is a pattern wound in about 0.5 turns. One end of the coil pattern 130 is connected to the other end of the coil pattern 120 in the conductor layer C2 through the via 13b formed in the interlayer insulating film 13, and the other end thereof is connected to the conductor post P2 through a via 14b formed in the interlayer insulating film 14. The connection pattern 131 is provided at a position overlapping the connection pattern 121 provided in the conductor layer C2. The connection pattern 131 is connected to the connection pattern 121 in the conductor layer C2 through the via 13a formed in the interlayer insulating film 13 and to the conductor post P1 through a via 14a formed in the interlayer insulating film 14.

With the above configuration, the coil patterns 100, 110, 120, and 130 are connected in series between the terminal electrodes E1 and E2 to form a coil of about 3.5 turns in total. The coil component 1 according to the present embodiment is an embedded type coil component in which the coil part 3 including the alternately stacked interlayer insulating films 10 to 14 and conductor layers C0 to C3 is embedded in the magnetic element body M, which is different in structure from a stacked type coil component in which magnetic sheets made of ceramic or the like and coil patterns are alternately stacked. For example, in the stacked type coil component, a magnetic sheet is interposed between coil patterns adjacent in the stacking direction, while in the coil component 1 according to the present embodiment, coil patterns adjacent in the stacking direction are insulated by the interlayer insulating film, and the magnetic element body M is not interposed between the coil patterns. The coil component 1 according to the present embodiment is also different in structure from a sheet coil of a type in which a coil pattern is formed on a printed board.

In the present embodiment, the coil patterns 100, 110, 120, and 130 and connection patterns, 111, 121, and 131 constituting the coil part 3 are insulated from the magnetic element body M by the interlayer insulating films 10 to 14, the conductor posts P1 and P2 are insulated from the magnetic element body M by the post protective film 15, and the terminal electrodes E1 and E2 are insulated from the magnetic element body M by the cover insulating film 21. Thus, all the conductor patterns are insulated from the magnetic element body M, allowing achievement of superior insulating properties.

Although the interlayer insulating films 10 to 14, post protective film 15, and cover insulating films 21 and 22 are not particularly limited in material, the post protective film 15 and cover insulating films 21 and 22 may be made of mutually different insulating materials. This is because the post protective film 15, which is embedded in the magnetic element body M and contacts the conductor posts P1 and P2, and the cover insulating films 21 and 22, which constitute the outermost layer of the coil component 1, are different in characteristics required to increase product reliability.

Specifically, for the post protective film 15, an insulating material containing a filler made of an inorganic material such as silica and thus having a low thermal expansion coefficient is selected, whereby it is possible to reduce a difference in thermal expansion coefficient from Cu which is the material of the conductor posts P1 and P2. On the other hand, for the cover insulating films 21 and 22, a resin material with a low Young's modulus is selected, whereby it is possible to enhance physical protection characteristics of the magnetic element body M on the mounting surface 4 and upper surface 5. Thus, the post protective film 15 is preferably made of an insulating material having a lower thermal expansion coefficient than the cover insulating films 21 and 22, and the cover insulating films 21 and 22 are preferably made of an insulating material having a lower Young's modulus than the post protective film 15. Further, filler may be added to an insulating material constituting the cover insulating films 21 and 22 depending on the required characteristics. For example, by adding a magnetic filler to the insulating material constituting the cover insulating films 21 and 22, inductance can be further increased.

Since the interlayer insulating films 10 to 14 are embedded in the magnetic element body M and contact the coil patterns 100, 110, 120, and 130 and the connection patters 111, 121, and 131, they may be made of the same insulating material as that of the post protective film 15. By selecting the same insulating material for the interlayer insulating films 10 to 14 and post protective film 15, material cost can be reduced.

The following describes a manufacturing method for the coil component 1 according to the present embodiment.

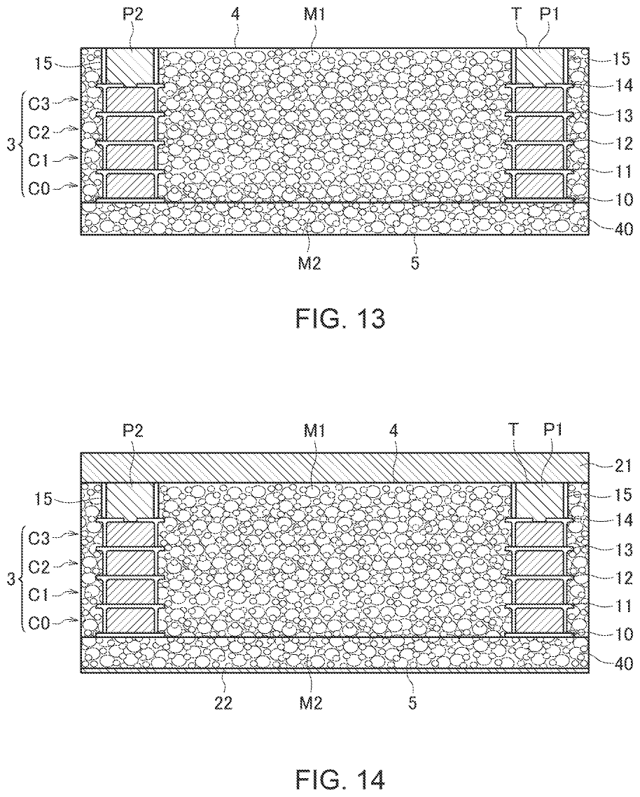

FIGS. 7 to 16 are process views for explaining the manufacturing method for the coil component 1 according to the present embodiment. Although FIGS. 7 to 16 each illustrate only an area corresponding to one coil component 1, a plurality of coil components 1 are actually manufactured at the same time using an aggregate substrate.

A support substrate 40 is prepared (FIG. 7), and the interlayer insulating films 10 to 14 and the conductor layers C0 to C3 are alternately formed to form the coil part 3. After that, the vias 14a and 14b are formed in the interlayer insulating film 14, and the conductor posts P1 and P2 are formed (FIG. 8). The conductor layers C0 to C3 and conductor posts P1 and P2 can be formed by electrolytic plating. The conductor layers C0 to C3 include a sacrificial pattern 41 positioned in the inner diameter area of the coil part 3 and in the outside area of the coil part 3.

Then, the post protective film 15 covering the entire exposed surface of each of the conductor posts P1 and P2 is formed (FIG. 9). The entire exposed surface of each of the conductor posts P1 and P2 includes the side surface S along the Z-direction and the upper surface T constituting the XY plane. In this state, wet etching is performed to remove the sacrificial pattern 41 (FIG. 10). The coil patterns constituting the coil part 3 are covered with the interlayer insulating films 10 to 14 and thus will not be etched. Similarly, the conductor posts P1 and P2 are covered with the post protective film 15 and thus will not be etched. As a result, a space 42 is formed in the inner diameter area and outside area of the coil part 3.

Then, the space 42 formed as a result of the removal of the sacrificial pattern 41 is filled with the magnetic resin layer M1 (FIG. 11). Then, the surface of the magnetic resin layer M1 is polished until the conductor posts P1 and P2 are exposed (FIG. 12). As a result, the mounting surface 4 of the magnetic resin layer M1 and the upper surfaces T of the respective conductor posts P1 and P2 are flush or substantially flush with one another. Further, as compared with a state before polishing, flatness of the magnetic resin layer M1 on the mounting surface 4 side is significantly enhanced. Then, after removal of the support substrate 40, the magnetic resin layer M2 is formed on the lower surface side of the magnetic resin layer M1 so as to cover the interlayer insulating film 10 (FIG. 13). After that, the surface of the magnetic resin layer M2 may be polished to smoothen the upper surface 5.

Then, the cover insulating films 21 and 22 are formed respectively on the mounting surface 4 and upper surface 5 of the magnetic element body M (FIG. 14). As a result, the upper surfaces T of the respective conductor posts P1 and P2 are covered with the cover insulating film 21. The film thickness of the cover insulating film 21 may be larger than the film thickness of the cover insulating film 22. When the magnetic element body M is pressed in this state by water pressure or the like, the magnetic element body M, which is in a temporarily cured state, is cured and contracts. Thus, the height position of the mounting surface 4 is slightly lowered, with the result that the conductor posts P1 and P2 and post protective film 15 slightly protrude from the mounting surface 4 (FIG. 15). The protruding portions of the respective conductor posts P1, P2 and post protective film 15 are embedded in the cover insulating film 21, and the protruding amount thereof can be adjusted by pressing force and pressing time.

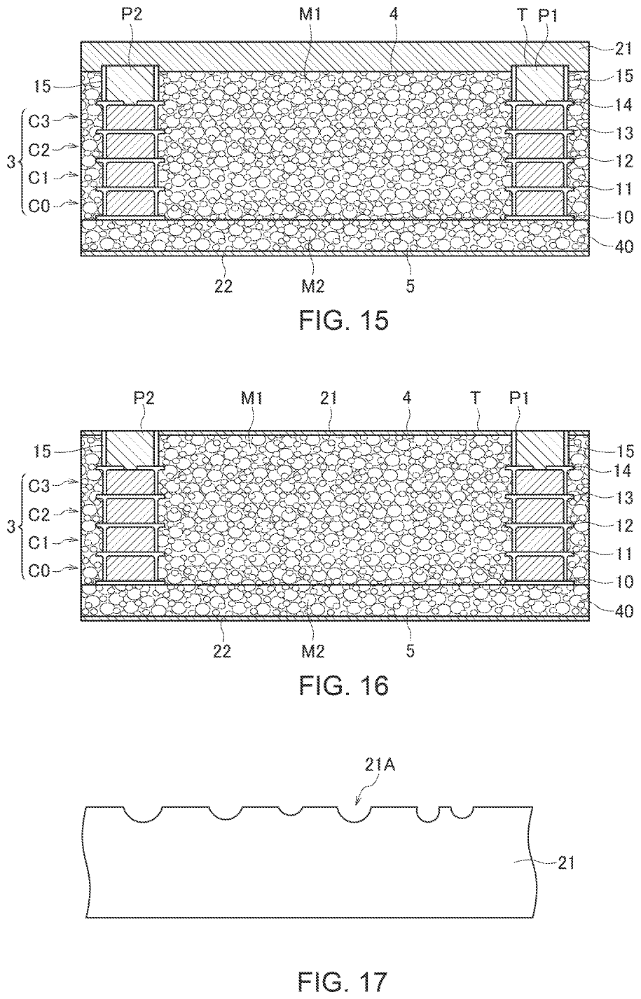

Then, the surface of the cover insulating film 21 is polished until the upper surfaces T of the respective conductor posts P1 and P2 are exposed (FIG. 16). At this polishing, the conductor posts P1 and P2 are used as a stopper, whereby the cover insulating film 21 covering the mounting surface 4 is left, and the openings 21a and 21b are formed in the cover insulating film 21. With the above process, the surface of the cover insulating film 21, the upper surfaces T of the respective conductor posts P1 and P2, and the end surface of the post protective film 15 are flush or substantially flush with one another. Further, the openings 21a and 21b are formed through polishing, so that the positions of the openings 21a and 21b are determined in a self-aligned manner with respect to the respective conductor posts P1 and P2, preventing misalignment therebetween. Further, when the cover insulating film 21 contains a filler, the filler is exposed by polishing, and the exposed filler partly drops from the cover insulating film 21, with the result that, as illustrated in FIG. 17, a plurality of drop marks are generated as recesses 21A.

Then, the terminal electrodes E1 and E2 are formed on the upper surfaces T of the respective conductor posts P1 and P2, followed by singulation by dicing, whereby the coil component 1 according to the present embodiment is completed. The conductor layer 31 can be formed by a thick-film formation method such as screen printing, and the conductor layer 32 can be formed by a barrel plating method or the like. Upon formation of the terminal electrodes E1 and E2, the upper surfaces T of the respective conductor posts P1 and P2 are not covered with the cover insulating film 21 but are entirely exposed from the mounting surface 4, so that a connection failure due to displacement of the formation positions of the terminal electrodes E1 and E2 is unlikely to occur.

As described above, in the present embodiment, after formation of the cover insulating film 21, the magnetic element body M is pressed to make the conductor posts P1 and P2 protrude from the mounting surface 4, followed by polishing of the cover insulating film 21 in this state, whereby the openings 21a and 21b can be formed in a self-aligned manner with respect to the respective conductor posts P1 and P2. In addition, when the cover insulating film 21 contains a filler, the plurality of recesses 21A, which are drop marks of the filler, are generated in the surface of the cover insulating film 21, so that even when the conductor layer 31 is formed by a thick-film formation method such as screen printing, the flow of the conductor layer 31 is prevented by the plurality of recesses 21A. This makes it unlikely to cause a short-circuit failure between the terminal electrodes E1 and E2 due to the flow of the conductor layer 31. Further, according to the above-described embodiment, it is possible to achieve a high-reliability component without through a process requiring high positional accuracy, such as forming the openings in the cover insulating film 21 at specified positions of the conductor posts P1 and P2.

While the preferred embodiment of the present disclosure has been described, the present disclosure is not limited to the above embodiment, and various modifications may be made within the scope of the present disclosure, and all such modifications are included in the present disclosure.

For example, although the coil part 3 includes four conductor layers C0 to C3 in the above embodiment, the number of conductor layers included in the coil part 3 is not particularly limited to a specific number. Further, although the coil patterns 100, 110, and 120 provided respectively in the conductor layers C0 to C2 are each wound in about one turn in the above embodiment, the number of turns of the coil pattern provided in each conductor layer is not particularly limited to a specific number.

Further, the conductor posts P1 and P2 are each not particularly limited in area and shape on the XY plane. For example, in a plan view as seen in the Z-direction, the conductor posts P1 and P2 may each entirely overlap the coil pattern 130 or connection pattern 131 and may partly protrude from the coil pattern 130 or connection pattern 131.

Further, in the above embodiment, the magnetic element body M is pressed after formation of the cover insulating film 21 to make the conductor posts P1 and P2 protrude from the mounting surface 4; however, the conductor posts P1 and P2 may be made to protrude from the mounting surface 4 by another method. For example, dry desmear treatment may be carried out at the stage illustrated in FIG. 12 or FIG. 13 to remove the magnetic resin layer M1 by a predetermined depth from the mounting surface 4 so as to make the conductor posts P1 and P2 protrude from the mounting surface 4. In this case, the cover insulating film 21 is formed after making the conductor posts P1 and P2 protrude from the mounting surface 4.

The technology according to the present disclosure includes the following configuration examples but not limited thereto.

A coil component according to one aspect of the present disclosure includes: a magnetic element body having a mounting surface; a coil pattern embedded in the magnetic element body; a conductor post embedded in the magnetic element body and whose one end is connected to the coil pattern; a cover insulating film covering the mounting surface of the magnetic element body; and a terminal electrode connected to the other end of the conductor post through an opening formed in the cover insulating film. The other end of the conductor post is flush with the surface of the cover insulating film. This increases the contact area between the conductor post and the terminal electrode, thereby reducing a connection resistance therebetween.

The above coil component may further include a post protective film provided between the conductor post and the magnetic element body. This can prevent contact between the conductor post and the magnetic element body.

In the above coil component, the end surface of the post protective film may be flush with the other end of the conductor post and the surface of the cover insulating film. This allows the conductor post to be protected more reliably by the post protective film.

In the above coil component, the cover insulating film and the post protective film may contact each other. This allows the side surface of the conductor post to be protected reliably by the post protective film.

In the above coil component, the cover insulating film may contain a filler, and a plurality of recesses which are drop marks of the filler may be generated in the surface of the cover insulating film. This can enhance positional accuracy of the terminal electrode.

A coil component manufacturing method according to one aspect of the present disclosure includes: a first step of embedding, in a magnetic element body, a coil pattern and a conductor post whose one end is connected to the coil pattern and the other end is exposed from a mounting surface of the magnetic element body; a second step of forming a cover insulating film on the other end of the conductor post and the mounting surface of the magnetic element body and making the other end of the conductor post protrude from the mounting surface of the magnetic element body; a third step of polishing the surface of the cover insulating film to such a degree that the other end of the conductor post is exposed and that the cover insulating film covering the mounting surface is left; and a fourth step of forming a terminal electrode on the other end of the conductor post. This allows an opening to be formed on the cover insulating film in a self-aligned manner with respect to the conductor post.

The above second step may be carried out by removing the magnetic element body by a predetermined depth from the mounting surface to make the other end of the conductor post protrude from the mounting surface of the magnetic element body and then forming the cover insulating film. This facilitates control of the protruding amount of the conductor post.

The above second step may be carried out by forming the cover insulating film and then pressing the magnetic element body to make the other end of the conductor post protrude from the mounting surface of the magnetic element body. This allows adjustment of the film thickness of the cover insulating film to be ultimately left by pressing force and pressing time.

What is claimed is:

1. A coil component comprising:
a magnetic element body having a mounting surface;
a coil pattern embedded in the magnetic element body;
a conductor post embedded in the magnetic element body, the conductor post having a first end connected to the coil pattern and a second end; and
a terminal electrode connected to the second end of the conductor post through an opening formed in the cover insulating film,
wherein the second end of the conductor post is flush with a surface of the cover insulating film.

2. The coil component as claimed in claim 1, further comprising a post protective film provided between the conductor post and the magnetic element body.

3. The coil component as claimed in claim 2, wherein an end surface of the post protective film is flush with the second end of the conductor post and the surface of the cover insulating film.

4. The coil component as claimed in claim 3, wherein the cover insulating film and the post protective film contact each other.

5. The coil component as claimed in claim 1,
wherein the cover insulating film contains a filler, and
wherein a plurality of recesses which are drop marks of the filler are generated in the surface of the cover insulating film.

6. A method of manufacturing a coil component, the method comprising:
embedding, in a magnetic element body, a coil pattern and a conductor post having a first end connected to the coil pattern and a second end exposed from a mounting surface of the magnetic element body;
forming a cover insulating film on the second end of the conductor post and the mounting surface of the magnetic element body and making the second end of the conductor post protrude from the mounting surface of the magnetic element body;
polishing a surface of the cover insulating film to such a degree that the second end of the conductor post is exposed and that the cover insulating film covering the mounting surface is left; and
forming a terminal electrode on the second end of the conductor post.

7. The method of manufacturing a coil component as claimed in claim 6, wherein the forming the cover insulating film is carried out by removing the magnetic element body by a predetermined depth from the mounting surface to make the second end of the conductor post protrude from the mounting surface of the magnetic element body and then forming the cover insulating film.

8. The method of manufacturing a coil component as claimed in claim 6, wherein the forming the cover insulating film is carried out by forming the cover insulating film and then pressing the magnetic element body to make the second end of the conductor post protrude from the mounting surface of the magnetic element body.
